(19) United States
(12) Patent Application Publication
(10) Pub. No.: US 2022/0084428 A1
(43) Pub. Date: Mar. 17, 2022

(54) LEARNING CONTENT RECOMMENDATION APPARATUS, SYSTEM, AND OPERATION METHOD THEREOF FOR DETERMINING RECOMMENDATION QUESTION BY REFLECTING LEARNING EFFECT OF USER

(71) Applicant: Hyun Bin LOH, Seoul (KR)

(72) Inventor: Hyun Bin LOH, Seoul (KR)

(73) Assignee: RIIID INC., Seoul (KR)

(21) Appl. No.: 17/476,443

(22) Filed: Sep. 15, 2021

(30) Foreign Application Priority Data
Sep. 16, 2020 (KR) 10-2020-00119163

(51) Int. Cl. G09B 7/04; G06N 3/04

(52) U.S. Cl. CPC G09B 7/04; G06N 3/04

(57) ABSTRACT

A learning content recommendation apparatus system, or method may be provided for determining a recommended question by reflecting a learning effect of a user. The apparatus, system or method may include: predicted score calculator configured to, on the basis of user information including a question previously solved by a user and a response of the user to the question, calculate predicted score information including a maximum predicted score and a minimum predicted score; a correct answer rate predictor configured to predict correct answer rate information, which is a probability that the user correctly answers the a candidate question, on the basis of the user information; and a recommended question determiner configured to calculate an expected score on the basis of one or more of the predicted score information, the correct answer rate information, and a degree of learning, and configured to determine a recommended question according to the expected score.

### CROSS-REFERENCE TO RELATED APPLICATION

This application claims priority from Korean Patent Application No. 10-2020-0119163, filed on Sept. 16, 2020 in the Korean Intellectual Property Office, the disclosure of which is incorporated herein by reference in its entirety.

### BACKGROUND OF THE INVENTION

### 1. Field of the Invention

The present disclosure relates to a learning content recommendation apparatus and system and an operation method thereof for determining a recommended question by reflecting a learning effect of a user, and more specifically, to a learning content recommendation apparatus and system and an operation method thereof capable of providing a user with a question identified to show the highest score improvement by reflecting the degree of learning of the user after learning, such as by reading explanations or by taking a video lecture for a question to which the user has answered incorrectly.

### 2. Discussion of Related Art

Recently, the Internet and electronic devices have been actively used in each field, and the educational environment is also changing rapidly. In particular, with the development of various educational media, learners may choose and use a wider range of learning methods. Among the learning methods, education services through the Internet have become a major teaching and learning method by overcoming time and space constraints and enabling low-cost education.

To keep up with the trend, customized education services, which are not available in offline education due to limited human and material resources, are also diversifying. For example, educational content that is subdivided according to the individuality and ability of a learner is provided using artificial intelligence so that the educational content is provided according to the individual competency of the learner, which departs from standardized education methods of the past.

In the education field, learning content has generally been recommended using a collaborating filter (CF). The CF is a method of predicting a correct answer rate for a given new question by collecting question-solving results of users. That is, under the assumption that, compared with another user who has a question solving history in the past similar to that of a user, a response of the user to a new question is expected to be similar to the question solving result of the another user, the CF predicts the correct answer rate. In the CF, a question with the highest probability of the user answering incorrectly, that is, a question having the correct answer rate predicted to be the lowest, has been recommended to the user.

The CF simply recommends a question with the highest probability of the user answering incorrectly and thus has difficulty in recommending a question that is really needed by the user. For example, a user who currently has a TOEIC score of 500 may be provided with a question that is barely solvable by a user who has a TOEIC score of 900, simply because the question has a high probability of being answered incorrectly. The user needs to gradually build up his or her skills from questions of a TOEIC score of 600 but has no choice but to be recommended with a high-level question having a low learning efficiency, which results in lowering of the learning efficiency.

### SUMMARY OF THE INVENTION

The present disclosure is directed to providing a learning content recommendation apparatus and system and an operation method thereof that are capable of providing a recommended question identified to show the highest score improvement (the highest expected score) through question solving so that a question that is most helpful in improving the skill of the user may be recommended.

The present disclosure is also directed to providing a learning content recommendation apparatus and system and an operation method thereof in which an expected score is calculated by reflecting an educational effect obtained as a user solves questions, such as by reading explanations for questions or by taking related lectures, and a recommended question is determined on the basis of the expected score so that the user's skill that improves through continuous learning may be reflected.

The technical objective of the present disclosure is not limited to the above, and other objectives may become apparent to those of ordinary skill in the art based on the following description.

According to an aspect of the present disclosure, there is provided a learning content recommendation apparatus and system and an operation method thereof capable of providing a user with a question identified to show the highest score improvement by reflecting the degree of learning of the user after learning, such as by reading explanations or by taking a video lecture for a question to which the user has answered incorrectly.

The learning content recommendation apparatus for determining a recommended question by reflecting a learning effect of a user includes: an estimated score calculator configured to, on the basis of user information including a question previously solved by a user and a response of the user to the question, calculate estimated score information including a maximum estimated score, which is an estimated score obtained when the user correctly answers a candidate question, and a minimum estimated score, which is an estimated score obtained when the user incorrectly answers the candidate question; a correct answer rate predictor configured to predict correct answer rate information, which is a probability that the user correctly answers the candidate question, on the basis of the user information; and a recommended question determiner configured to calculate an expected score on the basis of one or more of the estimated score information, the correct answer rate information, and a degree of learning, and determine a recommended question according to the expected score.

The recommended question determiner may include: a learning degree calculator configured to calculate the degree of learning, which is a probability that, after a first question, which has been previously solved incorrectly by the user, being learned by the user, the user solves a second question that is the same as or similar to the first question again and answers the second question correctly; and an expected score calculator configured to calculate a first expected score, in which the degree of learning is not reflected, on the basis of one or more of the estimated score information and the correct answer rate information, and calculate a second expected score, in which the degree of learning is reflected, on the basis of one or more of the first expected score, the maximum estimated score, and the degree of learning.

The operation method of the learning content recommendation apparatus for determining a recommended question by reflecting a learning effect of a user includes: sampling, by a sampler, a candidate question for determining a recommended question; receiving, by an estimated score calculator, the candidate question from the sampler and, on the basis of user information including a question previously solved by a user and a response of the user to the question, calculating estimated score information including a maximum estimated score, which is an estimated score obtained when the user correctly answers the candidate question, and a minimum estimated score, which is an estimated score obtained when the user incorrectly answers the candidate question; receiving, by a correct answer rate predictor, the candidate question from the sampler and predicting correct answer rate information, which is a probability that the user correctly answers the candidate question, on the basis of the user information; receiving, by a recommended question determiner, the estimated score information from the estimated score calculator and receiving the correct answer rate information from the correct answer rate predictor to calculate an expected score on the basis of one or more of the estimated score information, the correct answer rate information, and a degree of learning, and determining the recommended question according to the expected score; and transmitting the recommended question to a user terminal.

The determining of the recommended question may include: calculating the degree of learning, which is a probability that after a first question, which has been previously solved incorrectly by the user, being learned by the user, the user solves a second question that is the same as or similar to the first question again and answers the second question correctly; calculating a first expected score, in which the degree of learning is not reflected, on the basis of one or more of the estimated score information and the correct answer rate information; and calculating a second expected score, in which the degree of learning is reflected, on the basis of one or more of the first expected score, the maximum estimated score, and the degree of learning.

Other specific details of the present invention are included in the specification and the accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram for describing a learning content recommendation system according to an embodiment of the present disclosure;

FIG. 2 is a diagram for specifically describing an operation of a learning content recommendation apparatus according to an embodiment of the present disclosure;

FIG. 3 is a diagram for describing a recommended question determiner according to an embodiment of the present disclosure;

FIG. 4 is a graph for describing a calculation of an expected score in which a learning effect is reflected according to an embodiment of the present disclosure;

FIG. 5 is a flowchart showing an operation method of the learning content recommendation system according to an embodiment of the present disclosure; and

FIG. 6 is a flowchart for specifically describing operation S511 of FIG. 5.

### DETAILED DESCRIPTION OF PREFFERRED EMBODIMENTS

Hereinafter, embodiments of the present disclosure will be described in detail with reference to the accompanying drawings. In the drawings, the same parts throughout the drawings will be assigned the same number, and redundant descriptions thereof will be omitted.

It should be understood that, when an element is referred to as being “connected to” or “coupled to” another element, the element can be directly connected or coupled to another element, or an intervening element may be present. Conversely, when an element is referred to as being “directly connected to” or “directly coupled to” another element, there are no intervening elements present.

In the description of the embodiments, the detailed description of related known functions or constructions will be omitted herein to avoid making the subject matter of the present disclosure unclear. In addition, the accompanying drawings are used to aid in the explanation and understanding of the present disclosure and are not intended to limit the scope and spirit of the present disclosure and cover all modifications, equivalents, and alternatives falling within the spirit and scope of the present disclosure.

Specific embodiments are shown by way of example in the specification and the drawing but are merely intended to aid in the explanation and understanding of the technical spirit of the present disclosure rather than limiting the scope of the present disclosure. Those of ordinary skill in the technical field to which the present disclosure pertains should be able to understand that various modifications and alterations may be made without departing from the technical spirit or essential features of the present disclosure.

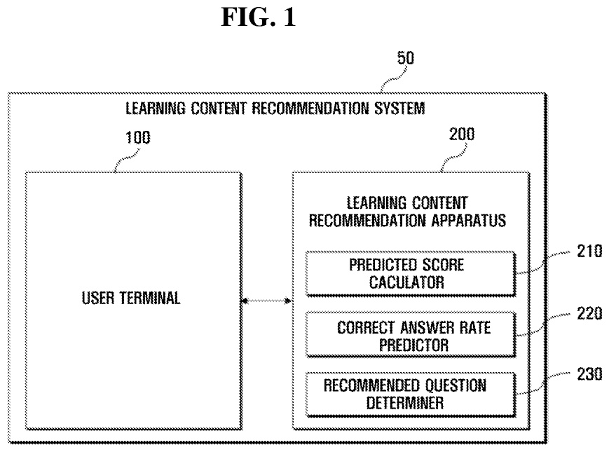

FIG. 1 is a diagram for describing a learning content recommendation system according to an embodiment of the present disclosure.

Referring to FIG. 1, a learning content recommendation system 50 according to the embodiment of the present disclosure may include a user terminal 100 and a learning content recommendation apparatus 200.

The learning content recommendation system 50 may provide the user terminal 100 with a question that is expected to have the highest learning efficiency based on questions solved by a user and responses to the questions solved by the user. In an embodiment, a recommended question may be a question expected to show the highest score improvement (the highest expected score) after the user solves the questions.

In the conventional education services through the Internet, a recommended question is determined using a collaborating filter (CF). In the CF, responses of existing users are collected, and the correct answer rate of a newcomer user is predicted. In the CF-based question recommendation, a question in which the correct answer rate is predicted to be the lowest, that is, a question with the highest probability of being answered incorrectly, is determined as the recommended question.

Because the CF simply recommends a question with the highest probability of being answered incorrectly, the user may be recommended questions that are not directly related to the improvement of the user's skill.

For example, a user currently having a TOEIC score of 500 may be provided with a question that is barely solvable by a user who has a TOEIC score of 900, simply because the question has the high possibility of being answered incorrectly. The user needs to gradually build up his or her skills from questions of a TOEIC score of 600 but has no choice but to be recommended with a high-level question having a low learning efficiency, which results in lowering the learning efficiency.

To solve such limitations, the learning content recommendation system 50 according to the embodiment of the present disclosure collects response information of a user and calculates an expected score that the user is expected to receive when solving a specific question. Then, a question having the highest expected score is determined as a recommended question and transmitted to the user terminal 100.

When a user currently having a TOEIC score of 500 is expected to receive a score of 530 after solving question A and is expected to receive a score of 570 after solving question B, the learning content recommendation system 50 provides a method of determining question B as a recommended question.

The learning content recommendation apparatus 200 may calculate an expected score through response information collected from the user terminal 100 and determine a recommended question based on the expected score. To this end, the learning content recommendation apparatus 200 may include a predicted score calculator 210, a correct answer rate predictor 220, and a recommended question determiner 230.

The predicted score calculator 210 may calculate a predicted score of a user for each case when the user answers a specific question correctly or when the user answers the specific question incorrectly on the basis of user information. In this case, the predicted score in the case of answering correctly to the question may be the maximum predicted score, and the predicted score in the case of answering incorrectly to the question may be the minimum predicted score. The user information may include a question previously solved by the user and a response of the user to the question. The user information may be updated in real time whenever the user solves a question.

A score expected to be obtained by the user after solving a specific question may be an expected score. As described above, the learning content recommendation system 50 according to the embodiment of the present disclosure may determine a question having the highest expected score as a recommended question.

The expected score may have a value within a range of the predicted scores. The expected score when the user answers a corresponding question correctly may correspond to the maximum predicted score, and the expected score when the user answers the corresponding question incorrectly may correspond to the minimum predicted score.

The learning content recommendation apparatus 200 may use the correct answer rate to obtain a fixed expected score value within a range of the predicted scores. The correct answer rate may be a probability that the user answers a corresponding question correctly.

The correct answer rate predictor 220 may predict the correct answer rate on the basis of the user information. Various artificial neural network models, including a recursive artificial neural network (RNN), a Long/Short-term memory (LSTM), a bidirectional LSTM, and a transformer structure-artificial neural network, may be used for predicting the correct answer rate. In an embodiment, when the transformer structure-artificial neural network is used, the correct answer rate of a question may be predicted by inputting question information to an encoder side and inputting response information to a decoder side.

The recommended question determiner 230 may determine a recommended question on the basis of predicted score information calculated by the predicted score calculator 210 and correct answer rate information predicted by the correct answer rate predictor 220. The recommended question may be a question with the highest expected score calculated through the predicted score information and the correct answer rate information.

However, the recommended question is not limited to a single question with the highest expected score. According to another embodiment, a preset number of questions in the order from having the highest expected score may be determined as the recommended question, or a question having an expected score greater than a preset value may be determined as the recommended question.

The recommended question determiner 230 may calculate an expected score according to a preset algorithm. The algorithm may include a first algorithm and/or a second algorithm, and in some cases, by using one or more of the two algorithms, the expected score may be calculated.

The first algorithm is an algorithm that calculates an expected score using only predicted score information and correct answer rate information without reflecting the degree of learning. Referring to Equation 1 below, user information collected up to t questions may be denoted as Iᵤ^{t}, a t+1^{th} question for which the expected score is desired to be predicted may be denoted as q^{t+1}, and an expected response of the user for the t+1^{th} question may be denoted as r^{t+1}.

In this case, an expected score according to the first algorithm in which the degree of learning is not reflected may be Eₚ└S(Iᵤ^{t}, (q^{t+1}, r^{t+2}))┘, a predicted score (i.e., the maximum predicted score) when the user correctly answers the question may be S(Iᵤ^{t}, (q^{t+1}, 1)), a predicted score (i.e., the minimum predicted score) when the user incorrectly answers the question may be S(Iᵤ^{t}, (q^{t+1}, 0)), and a correct answer rate that the user correctly answers the t+1^{th} question may be p(q^{t+1}|Iᵤ^{t}).

Referring to Equation 1 below, the expected score according to the first algorithm may be calculated by adding up “a value obtained by multiplying the correct answer rate by the maximum predicted score” and “a value obtained by multiplying the wrong answer rate by the minimum predicted score.”

Eₚ[S(Iᵤ^{t}, (q^{t+1}, r^{t+1}))]=p(q^{t+1}|Iᵤ^{t})S(Iᵤ^{t}, (q^{t+1}, 1))+(1−p(q^{t+1}|Iᵤ^{t}))S(Iᵤ^{t}, (q^{t+1}, 0)) [Equation 1]

On the other hand, the expected score according to the second algorithm in which the degree of learning is reflected may be described with reference to Equation 2. In this case, the degree of learning may be denoted as α. Referring to Equation 2 below, the expected score in which the degree of learning is reflected may be calculated by adding up “a value obtained by multiplying the degree of learning by the maximum predicted score” and “a value obtained by multiplying the degree of non-learning 1−α by the expected score in which the degree of learning is not reflected.”

αS(Iᵤ^{t}, (q^{t+1}, 1))+(1−α)Eₚ[S(Iᵤ^{t}, q^{t+1}, r^{t+1}))]=(α+(1−α)p(q^{t+1}|Iᵤ^{t}))S(Iᵤ^{t}, (q^{t+1}, 1))+(1−α)(1−p(q^{t+1}|Iᵤ^{t}))S(Iᵤ^{t}, (q^{t+1}, 0)) [Equation 2]

The learning content recommendation system 50 according to the embodiment of the present disclosure may reflect the degree of learning, which is information about an educational effect generated when solving questions, such as by reading explanations for questions or by taking related lectures, in calculating the expected score.

The degree of learning may be calculated from the probability that after a previous incorrectly solved question, which has been previously solved incorrectly by the user, being learned by the user, the user solves a question that is the same as or similar to the previous incorrectly solved question again and answers the previous incorrectly solved question correctly. The question solved again may include a plurality of questions, and in this case, the degree of learning may be an average correct answer rate for questions given to the user at least once.

However, according to embodiments, the calculating of the degree of learning is not limited to the correct answer rate for the same or similar question and may simultaneously use one or more of various variables (e.g., the probability of dropping out during learning, a question solving time, the number of questions solved, etc.) that may be considered in a question solving environment of the user.

The recommended question determiner 230 may calculate the expected score on the basis of the predicted score information, the correct answer rate information, and the degree of learning. The calculated expected score may be iteratively performed on each of a plurality of questions. The expected score expected to be obtained by the user after solving a certain question is calculated for each question, and on the basis of the expected score, a question expected to have the highest expected score may be provided to the user as a recommended question.

According to the learning content recommendation system 50 according to the embodiment of the present disclosure, an expected score is calculated for each question, and a recommended question is determined on the basis of the calculated expected score so that a question that is optimized to improve the user's score may be recommended compared to simply recommending a question with a high probability of being answered wrong.

In addition, with the learning content recommendation system 50 according to the embodiment of the present disclosure, artificial intelligence is utilized to provide educational content subdivided according to the learning ability of a learner so that the educational content is provided according to the individual competency of the learner, which departs from standardized education methods of the past.

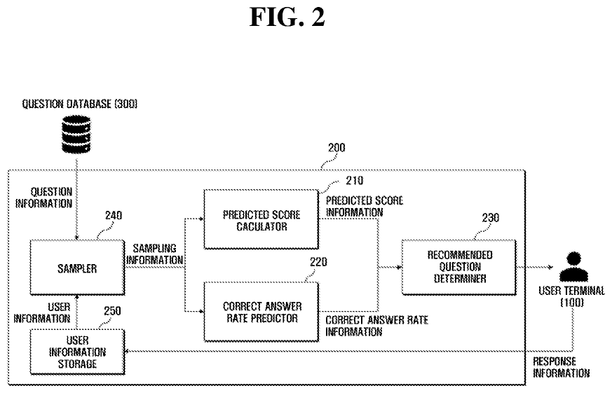

FIG. 2 is a diagram for specifically describing an operation of a learning content recommendation apparatus according to an embodiment of the present disclosure.

Referring to FIG. 2, the learning content recommendation apparatus 200 includes a sampler 240 and a user information storage 250 in addition to the predicted score calculator 210, the correct answer rate predictor 220, and the recommended question determiner 230 as shown in FIG. 1 above.

The learning content recommendation apparatus 200 may calculate an expected score for each question and determine a question having the highest expected score as the recommended question. In this case, calculating the expected scores for all question in question database 300 consumes a large amount of resources and thus the overall performance may be lowered.

Accordingly, the sampler 240 may receive question information from the question database 300 and sample candidate questions for determining a recommended question. The learning content recommendation apparatus 200 may calculate the expected score only for candidate questions sampled to determine the recommended question.

The sampler 240 may sample candidate questions in various ways according to embodiments. The sampling method may include one or more of: 1) selecting random questions, 2) selecting questions in which the average correct answer rate of the user is low, 3) selecting the latest questions in which trends are reflected, and 4) selecting questions with a high concentration of users, but is not limited thereto.

The sampler 240 may sample candidate questions and receive user information from the user information storage 250 to generate sampling information. The sampling information may include question information which is information about the sampled questions, and the user information. Thereafter, the sampler 240 may transmit the sampling information to the predicted score calculator 210 and the correct answer rate predictor 220.

The predicted score calculator 210 may generate predicted score information on the basis of the sampling information. Specifically, the predicted score calculator 210 may calculate the predicted score of the user for each case of being correct for the sampled candidate question and a case of being wrong for the sampled candidate question on the basis of the user information. The predicted score in the case of being correct for the question may be the maximum predicted score, and the predicted score in the case of being wrong for the question may be the minimum predicted score.

The correct answer rate predictor 220 may use a correct answer rate to obtain a fixed expected score value within a range of the predicted scores. The correct answer rate may be a probability that the user correctly answers a corresponding question. The expected score may have a value within a range of the predicted scores. The expected score when the user correctly answers the corresponding question may be the maximum predicted score, and the expected score when the user incorrectly answers the corresponding question may be the minimum predicted score.

The correct answer rate predictor 220 may predict the correct answer rate on the basis of the user information. Various artificial neural network models, including a recursive artificial neural network (RNN), a long short-term memory (LSTM), a bidirectional LSTM, and a transformer structure-artificial neural network, may be used for predicting the correct answer rate. In an embodiment, when the transformer structure-artificial neural network is used, the correct answer rate of a question may be predicted by inputting question information to an encoder side and inputting response information to a decoder side.

The recommended question determiner 230 may determine a recommended question on the basis of predicted score information calculated by the predicted score calculator 210 and correct answer rate information predicted by the correct answer rate predictor 220. The recommended question may be a question with the highest expected score calculated on the basis of the predicted score information and the correct answer rate information.

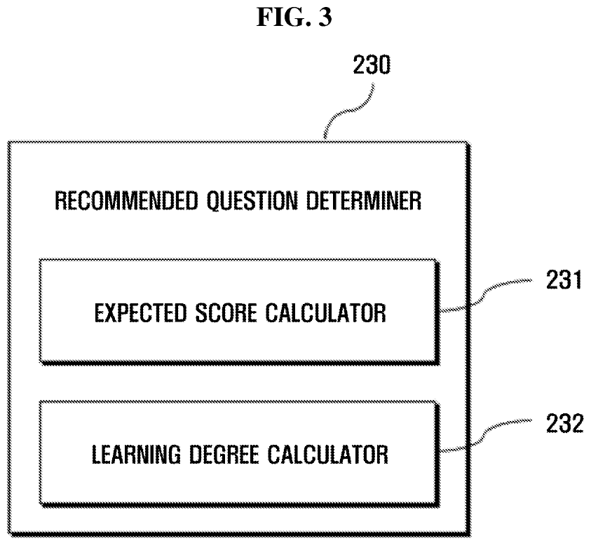

The recommended question determiner 230 may use the degree of learning when calculating the expected score. The degree of learning may include information about an educational effect generated when solving questions, such as by reading explanations for questions or by taking related lectures. A process of calculating the expected score using the degree of learning will be described in detail with reference to FIG. 3 below.

The recommended question determiner 230 may provide the determined recommended question to the user terminal 100. The user may provide a result of solving the recommended question to the user information storage 250 as response information.

FIG. 3 is a diagram for describing a recommended question determiner according to an embodiment of the present disclosure.

Referring to FIG. 3, the recommended question determiner 230 may include an expected score calculator 231 and a learning degree calculator 232.

The expected score calculator 231 may calculate an expected score from the predicted score according to the first algorithm and/or the second algorithm.

The first algorithm may be an algorithm that calculates an expected score using only predicted score information and correct answer rate information without reflecting the degree of learning. According to the first algorithm, the expected score may be calculated by adding up “a value obtained by multiplying the correct answer rate by the maximum predicted score” and “a value obtained by multiplying the wrong answer rate by the minimum predicted score.”

The expected score calculated according to the first algorithm is an expected score in which the degree of learning a is not reflected. The expected score, in which the degree of learning is not reflected, does not sufficiently reflect a skill improvement of a user who has learned, such as by reading explanations after solving questions or taking lectures, and thus has a difficulty in recommending learning content that is the most suitable for the current skill of the user.

On the other hand, the second algorithm may be an algorithm that calculates an expected score by reflecting the degree of learning. The second algorithm may calculate an expected score using the degree of learning, predicted score information, and correct answer rate information. According to the second algorithm, the expected score in which the degree of learning is reflected may be calculated by adding up “a value obtained by multiplying the degree of learning by the maximum predicted score” and “a value obtained by multiplying the degree of non-learning (1−α) by the expected score in which the degree of learning is not reflected.”

Even when the expected score is calculated using the second algorithm, the use of the first algorithm may be accompanied because the expected score in which the degree of learning is not reflected is used for calculating the expected score in which the degree of learning is reflected.

Since the expected score calculated according to the second algorithm reflects the degree of learning, the skill of the user, which is improved in each step of question solving, may be reflected. Therefore, a question in which the current skill of the user is reflected is provided as the learning content so that effective learning is enabled.

The user information storage 250 may receive response information for the recommended question from the user terminal 100 and store the response information. Thereafter, the user information storage 250 may update the user information according to the received response information and provide the user information for calculating a new recommended question. The user information storage 250 may provide the user information to the predicted score calculator 210 and the correct answer rate predictor 220 for AI prediction and store response information according to question solving of a user.

In FIG. 2, the user information is illustrated as being provided to the predicted score calculator 210 and the correct answer rate predictor 220 through the sampler 240, but this is only an example and the user information may be provided to the predicted score calculator 210 and the correct answer rate predictor 220 without passing through the sampler 240.

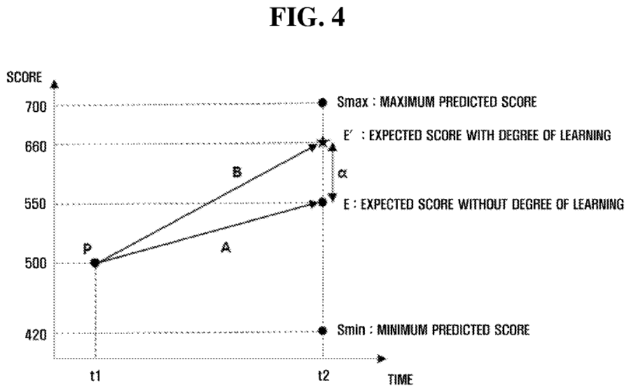

FIG. 4 is a graph for describing a calculation of an expected score in which a learning effect is reflected according to an embodiment of the present disclosure.

Referring to FIG. 4, the graph shows a change in the scores of a user over time.

P represents the current state of a user. In t1, the user has a skill of 500 points. The user may be provided with an improved skill in t2 after learning, such as by solving questions and reading explanations, or by taking related lectures.

The learning content recommendation system 50 according to the embodiment of the present disclosure may calculate a predicted score and an expected score of the user expected after solving a question. The predicted score may include a maximum predicted score Smax when the question is answered correctly and a minimum predicted score Smin when the question is answered incorrectly.

In the embodiment of FIG. 4, when the question is answered incorrectly, the predicted score of the user may be 420 points, and when the question is answered correctly, the predicted score of the user may be 700 points. The expected score has a value within a range of the predicted scores and may be calculated by reflecting the correct answer rate of the user for the question.

Path A is a process of calculating the expected score E in which the degree of learning is not reflected. The expected score E in which the degree of learning is not reflected may be calculated using the maximum predicted score Smax, the minimum predicted score Smin, and the correct answer rate.

The expected score, in which the degree of learning is not reflected, does not actually reflect the skill of the user improved after learning in practice, thus having a score lower than an expected score E′ in which the degree of learning is reflected. In FIG. 4, the expected score E′ in which the degree of learning is reflected is 660 points while the expected score E in which the degree of learning is not reflected is 550 points.

Path B is a process of calculating the expected score E′ in which the degree of learning is not reflected. The expected score E in which the degree of learning is reflected may be calculated using the maximum predicted score Smax, the minimum predicted score Smin, the correct answer rate, and the degree of learning.

The expected score E′ in which the degree of learning is reflected may be calculated by calculating the expected score E in which the degree of learning is not reflected according to path A and using the expected score E. The specific equation may be understood through Equation 2 described above.

The degree of learning may include information about an educational effect generated when solving questions such as by reading explanations for questions or by taking related lectures. Because the expected score is calculated by reflecting the degree of learning, the skill of the user improved after learning may be reflected in real time.

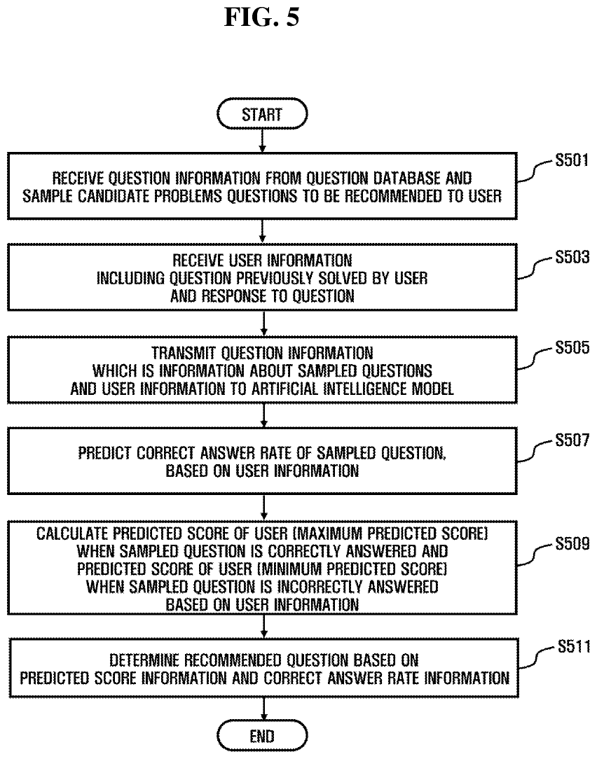

FIG. 5 is a flowchart showing an operation method of the learning content recommendation system according to an embodiment of the present disclosure.

Referring to FIG. 5, in operation S501, the learning content recommendation system 50 may receive question information from the question database 300 and sample candidate questions from the received question information.

The sampling of candidate questions for which expected scores are to be calculated first by the learning content recommendation system 50 is because calculating expected scores for all questions in the question database 300 requires a large amount of resources and may cause degradation of the overall performance

In operation S503, the learning content recommendation system 50 may receive user information including a question previously solved by the user and a response to the question.

The user information may include a pair of a question and a response to the question. The user information may be updated by reflecting a solution result whenever the user solves a question.

In operation S505, the learning content recommendation system 50 may transmit question information which is information about the sampled questions and the user information to the artificial intelligence model. The question information about the sampled questions and the user information may form sampling information.

The learning content recommendation system 50 may predict a predicted score and a correct answer rate by inputting the sampling information into the artificial intelligence model. The predicted score and the correct answer rate may be predicted using different AI models optimized therefor, respectively.

Specifically, in operation S507, the learning content recommendation system 50 may predict the correct answer rate of the sampled question on the basis of the user information. In operation S509, the learning content recommendation system 50 may calculate an predicted score of the user (the maximum predicted score) when the sampled question is correctly answered and an predicted score of the user (the minimum predicted score) when the sampled question is incorrectly answered on the basis of the user information.

In operation S511, the learning content recommendation system 50 may determine a recommended question on the basis of predicted score information and correct answer rate information, and provide the determined recommended question to the user.

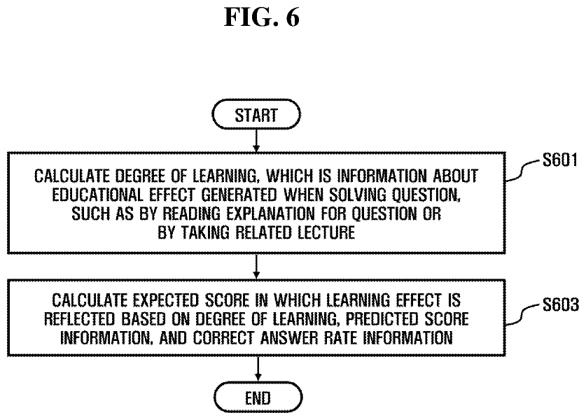

Operation S511 is described in more detail with reference to FIG. 6, in which operation S511 includes operation S601 of calculating the degree of learning, which is information about an educational effect generated when solving a question, such as by reading an explanation for a question or by taking a related lecture and operation S603 of calculating an expected score in which a learning effect is reflected on the basis of the degree of learning, the predicted score information, and the correct answer rate information.

In the above description, the embodiments of the present disclosure have been described with reference to FIGS. 1 to 6. Each of the user terminal 100 and the learning content recommendation apparatus 200 shown in FIGS. 1 to 3 may be a computing device including one or more processors.

In addition, elements forming the learning content recommendation apparatus 200 may be implemented in the form of modules. The module may refer to software or hardware, such as a Field Programmable Gate Array (FPGA) or an Application Specific Integrated Circuit (ASIC), and may perform predetermined functions. However, the “modules” are not limited to meaning software or hardware. Each of the modules may be configured to be stored in a storage medium capable of being addressed and configured to execute one or more processors. For example, the modules may include elements such as software elements, object-oriented software elements, class elements, and task elements, processes, functions, attributes, procedures, subroutines, segments of a program code, drivers, firmware, microcode, circuits, data, databases, data structures, tables, arrays, and variables. Functions provided in elements and modules may be combined into fewer elements and modules or may be further divided into additional elements and modules.

As is apparent from the above, the learning content recommendation apparatus and system and the operation method thereof according to the present disclosure can provide a recommended question identified to show the highest score improvement (the highest expected score) through question solving so that a question that is most helpful in improving the user's skill can be recommended.

In addition, with the learning content recommendation apparatus and system and the operation method thereof according to the present disclosure, an expected score is calculated by reflecting an educational effect obtained as a user solves questions, such as by reading explanations for questions or by taking related lectures, and a recommended question is determined on the basis of the expected score, thereby the user's skill that improves through continuous learning can be reflected in real time.

Specific embodiments are shown by way of example in the specification and the drawing but are merely intended to aid in the explanation and understanding of the technical spirit of the present disclosure rather than limiting the scope of the present disclosure. Those of ordinary skill in the technical field to which the present disclosure pertains should be able to understand that various modifications and alterations may be made without departing from the technical spirit or essential features of the present disclosure.

What is claimed is:

1. A learning content recommendation apparatus for determining a recommended question by reflecting a learning effect of a user, the learning content recommendation apparatus comprising:
a predicted score calculator configured to, on the basis of user information including a question previously solved by a user and a response of the user to the question, calculate predicted score information including a maximum predicted score, which is a predicted score obtained when the user correctly answers a candidate question, and a minimum predicted score, which is a predicted score obtained when the user incorrectly answers the candidate question;
a correct answer rate predictor configured to predict correct answer rate information, which is a probability that the user correctly answers the candidate question, on the basis of the user information; and
a recommended question determiner configured to calculate an expected score on the basis of one or more of the predicted score information, the correct answer rate information, and a degree of learning, and determine a recommended question according to the expected score,
wherein the recommended question determiner includes:
a learning degree calculator configured to calculate the degree of learning, which is a probability that, after a first question, which has been previously solved incorrectly by the user, being learned by the user, the user solves a second question that is the same as or similar to the first question again and answers the second question correctly; and
an expected score calculator configured to calculate a first expected score, in which the degree of learning is not reflected, on the basis of one or more of the predicted score information and the correct answer rate information, and calculate a second expected score, in which the degree of learning is reflected, on the basis of one or more of the first expected score, the maximum predicted score, and the degree of learning.

2. The learning content recommendation apparatus of claim 1, further comprising:
a sampler configured to receive question information from a question database and sample candidate questions for determining the recommended question; and
a user information storage configured to provide the user information to the predicted score calculator and the correct answer rate predictor for artificial intelligence prediction and store response information according to question solving of the user.

3. The learning content recommendation apparatus of claim 2,
wherein the correct answer rate predictor is configured to predict the correct answer rate using an artificial neural network model related to one or more among a recursive artificial neural network (RNN), a long short-term memory (LSTM), a bidirectional LSTM, and a transformer structure-artificial neural network, and
in the transformer structure-artificial neural network, the question information is input to an encoder side and the response information is input to a decoder side to predict the correct answer rate.

4. The learning content recommendation apparatus of claim 1,
wherein the expected score calculator includes a first algorithm, and
wherein the first algorithm calculates the first expected score on the basis of the predicted score information and the correct answer rate information.

5. The learning content recommendation apparatus of claim 1,
wherein the expected score calculator includes a second algorithm, and
wherein the second algorithm calculates the second expected score on the basis of the predicted score information, the correct answer rate information, and the degree of learning.

6. An operation method of a learning content recommendation apparatus for determining a recommended question by reflecting a learning effect of a user, the operation method comprising:
sampling, by a sampler, a candidate question for determining a recommended question;
receiving, by a predicted score calculator, the candidate question from the sampler and, on the basis of user information including a question previously solved by a user and a response of the user to the question, calculating predicted score information including a maximum predicted score, which is a predicted score obtained when the user correctly answers the candidate question, and a minimum predicted score, which is a predicted score obtained when the user incorrectly answers the candidate question;
receiving, by a correct answer rate predictor, the candidate question from the sampler and predicting correct answer rate information, which is a probability that the user correctly answers the candidate question, on the basis of the user information;
receiving, by a recommended question determiner, the predicted score information from the predicted score calculator and receiving the correct answer rate information from the correct answer rate predictor to calculate an expected score on the basis of one or more of the predicted score information, the correct answer rate information, and a degree of learning, and determining the recommended question according to the expected score; and
transmitting the recommended question to a user terminal,
wherein the determining the recommended question includes:
calculating the degree of learning, which is a probability that after a first question, which has been previously solved incorrectly by the user, being learned by the user, the user solves a second question that is the same as or similar to the first question again and answers the second question correctly;
calculating a first expected score, in which the degree of learning is not reflected, on the basis of one or more of the predicted score information and the correct answer rate information; and
calculating a second expected score, in which the degree of learning is reflected, on the basis of one or more of the first expected score, the maximum predicted score, and the degree of learning.
